(19) United States
(12) Patent Application Publication
(10) Pub. No.: US 2009/0148065 A1
(43) Pub. Date: Jun. 11, 2009

(54) Real-time summation of images from a plurality of sources

(76) Inventor: Mark J. Halsted, Wyoming, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 12/313,918

(22) Filed: Nov. 25, 2008

Related U.S. Application Data
(60) Provisional application No. 61/005,642, filed on Dec. 6, 2007.

(51) Int. Cl. G06K 9/36

(52) U.S. Cl. 382/284

(57) ABSTRACT

A method of producing an image depicting an object from a plurality of images. In an exemplary method, images of an object gathered by a plurality of image acquisition devices are combined to produce a final image. Low quality image rejection, enhancement, co-registration, and other functions may be performed. An exemplary system includes a plurality of cameras coupled to respective telescopes. The cameras are connected to a computing device via one or more networks, and the computing device combines images acquired by the cameras to produce a final image.

### CROSS REFERENCE TO RELATED APPLICATION

This application claims the benefit of U.S. Provisional Application No. 61/005,642, filed Dec. 6, 2007, which is incorporated by reference.

### BACKGROUND

The present disclosure relates to systems and methods that provide real-time summation of images from a plurality of sources to reduce image acquisition time and improve image quality. More specifically, the present invention pertains to a computerized system and method that provides for the real-time summation, storage, retrieval, and display of images as they are acquired by a plurality of imaging devices that are equipped with video or still cameras.

### SUMMARY

Exemplary embodiments include a method of producing an image depicting an object from a plurality of images. In an exemplary method, images of an object gathered by a plurality of image acquisition devices are combined to produce a final image. Low quality image rejection, enhancement, co-registration, and other functions may be performed. An exemplary system includes a plurality of cameras coupled to respective telescopes. The cameras are connected to a computing device via one or more networks, and the computing device combines images acquired by the cameras to produce a final image.

In an aspect, a method of producing an image may include receiving a first stack of images acquired using a first image sensing device, where the first stack of images includes a plurality of images depicting a target object; receiving a second stack of images acquired using a second image sensing device, where the second stack of images includes a plurality of images depicting the target object; combining the first stack of images and the second stack of images to produce a combined stack of images; and processing the combined stack of images to produce a final image.

In a detailed embodiment, the method may include eliminating at least one image from at least one of the first stack of images, the second stack of images, and the combined stack of images based upon a quality evaluation.

In another detailed embodiment, the steps of receiving the first stack of images, receiving the second stack of images, combining the first stack of images and the second stack of images, and processing the combined stack of images may be performed using a central computing device. In a further detailed embodiment, the first stack of images may be received by the central computing device from a first computing device, and the method may include, after the step of processing the combined stack of images, transmitting the final image to the first computing device. In a still further detailed embodiment, the second stack of images may be received by the central computing device from a second computing device, and the first computing device, the second computing device, and the central computing device may be operatively connected via at least one network providing at least real time communications capability. In another further detailed embodiment, the first computing device may be located near the first image sensing device, and the central computing device may be located remotely from the first image sensing device.

In another detailed embodiment, the step of processing the combined stack of images may include co-registering the combined stack of images. In a further detailed embodiment, co-registering the combined stack of images may include removing from the combined stack of images at least one image of a relatively lower quality. In a still further detailed embodiment, co-registering may include identifying at least one alignment point in each of the images in the combined stack of images. In yet a further detailed embodiment, co-registering may include identifying a plurality of alignment points in each of the images in the combined stack of images.

In another detailed embodiment, the first stack of images and the second stack of images may each include images that were acquired during a particular period of time.

In another detailed embodiment, the method may include receiving a communication from a first user associated with the first image sensing device, and transmitting the communication to a second user associated with the second image sensing device.

In another detailed embodiment, the method may include, after the step of processing the combined stack of images, transmitting the final image to a receiving computing device not associated with the first image sensing device, the second image sensing device, or the central computing device. In a further detailed embodiment, the receiving computing device may include a storage device, and the storage device may be operative to supply the final image upon request.

In another detailed embodiment, the steps of receiving the first stack of images, receiving the second stack of images, combining the first stack of images and the second stack of images, and processing the combined stack of images may be performed at least in near real time.

In another aspect, a method of producing an image may include acquiring a first stack of images of an object using a first image acquisition device; transmitting the first stack of images to a central computing device; and receiving, from the central computing device, a final image the object produced using at least the first stack of images and a second stack of images; where the second stack of images includes a plurality of images of the object acquired by a second image acquisition device and received by the central computing device.

In a detailed embodiment, the method may include eliminating at least one image from at least one of the first stack of images, the second stack of images, and the combined stack of images based upon a quality evaluation.

In another detailed embodiment, the central computing device may be located remotely from the first image acquisition device. In another detailed embodiment, the first stack of images and the second stack of images may each include images that were acquired during a particular period of time. In another detailed embodiment, the method may include receiving a first communication from a user associated with the second image sensing device, and transmitting a second communication to the user associated with the second image sensing device.

In another aspect, a system for producing an image may include a first image sensing device operative to gather a first stack of images depicting an object; a second image sensing device operative to gather a second stack of images depicting the object; and at least one computing device operatively coupled to the first image sensing device and the second image sensing device; where the computing device is operative to combine images from the first stack of images and images from the second stack of images into a combined stack of images; and where the computing device is operative to process the combined stack of images to produce a final image.

In a detailed embodiment, at least one of the first image sensing device and the second image sensing device may be terrestrially located. In a further detailed embodiment, the object may be extraterrestrially located.

In another detailed embodiment, the system may include a storage device operatively coupled to the computing device, where the storage device includes a plurality of final images. In another detailed embodiment, the system may include a display device located near the first image sensing device, where the image sensing device is operative to display the final image. In another detailed embodiment, at least one of the first image sensing device and the second image sensing device may be operatively coupled to at least one telescope.

### BRIEF DESCRIPTION OF THE DRAWINGS

The detailed description refers to the following figures in which:

FIG. 1 is a flow diagram showing an exemplary image-producing system.

FIG. 2 is a schematic diagram showing exemplary image-gathering devices.

FIG. 3 is a is a flow diagram showing an exemplary co-registration process.

FIG. 4 is a partial screen capture of an exemplary instant messaging platform.

FIG. 5 is a schematic diagram showing an exemplary image-producing system.

### DETAILED DESCRIPTION

One application of exemplary embodiments of the device disclosed herein is in the field of astrophotography. Even low resolution video or still cameras, such as those used for real-time web-based video conferencing, can be used in conjunction with relatively small aperture telescopes to acquire “stacks” of images that, when post-processed to remove noise and thus enhance signal, rival the static images of much larger telescopes. A single, small aperture telescope can be paired with such a camera and focused on an object for several minutes to hours, while the camera captures and stores a “stack” of dozens to hundreds of images. By co-registering these images, discarding those of poor quality caused by intermittent air turbulence or otherwise degraded by transient artifacts, and removing the noise in the images while preserving the signal, image processing software can be used to produce very high quality static images. This technique can be used to produce striking images using relatively small telescopes. Such images can rival the best images from earth-based observatories.

Cameras linked to telescopes may also be used to provide near-real-time images that are created on the fly from “stacks” of several images acquired over several seconds to minutes—such images may be displayed during observing sessions on LCD (liquid crystal display) or other monitors at or distant from the observation site. This technique is much more sensitive to faint objects, colors, nebulae, and other subtleties than is the naked eye peering through the telescope eyepiece, because the newer CCD (charge-coupled device) cameras are capable of detecting and displaying single photons of light, and are capable of acquiring multiple images over many seconds, “stacking” them into a single image, and displaying that single image onscreen. This technique, in which a relatively sparse stream of photons is summed over many seconds to produce a single image, is much more sensitive to faint objects than the human eye, since the human visual system is neither as sensitive as CCD cameras to single photons of light, nor as able to slow its refresh rate as are such cameras. As a result, many astronomers are finding that replacing the eyepieces of their telescopes with CCD still or video cameras can significantly increase their sensitivity for faint objects. See, e.g., U.S. Pat. No. 5,525,793 to Holmes et al., which is incorporated by reference.

Faint objects can be more easily seen with this technology, and whereas astrophotographers once relied on long exposure times to acquire static images of very faint objects, the near-real time resolution provided by CCD cameras as they dynamically stack and display images effectively eliminates this delay—which represents a significant advantage over traditional long-exposure still astrophotography.

Moreover, such camera systems can render color images. Due to the physiology of the human visual system, very dim light is only perceptible in black and white, and thus images seen in real time through a telescope eyepiece with the naked eye appear black and white. To achieve color resolution of nebulae, galaxies, and other astronomical bodies, astronomers have had to employ cameras and long exposure times. CCD still or video cameras coupled with telescopes have made full color observation with near-real time resolution a reality.

Exemplary embodiments may combine the images from a plurality of telescopes or other imaging systems in real time, effectively constructing “stacks” by combining images from a plurality of input sources simultaneously, obtaining the benefits of large image stacks (previously acquired with a CCD still or video camera mounted on a single telescope collecting many image frames and stacking them) in a fraction of the time that it has taken to acquire them with a single source.

Atmospheric turbulence affects all earth-bound observers, and observatories. Any thermal or particulate-induced imperfections in the column of air between the aperture of the telescope and the edge of the atmosphere causes degradation of the quality of the image seen through the telescope. The larger the telescope aperture, the more susceptible it is to such interference. Thus observers in particularly light-polluted areas or areas with other atmospheric interference generally find that smaller aperture telescopes perform better in such suboptimal “seeing” conditions. However, the smaller the telescope aperture, the less sensitive it is to faint objects. While astrophotographers can compensate for this to some degree by employing long exposure times, thus effectively increasing the sensitivity of their systems to faint light, longer exposure times increase susceptibility to motion artifact. Moreover, each high quality image of a faint object may require several hours to acquire—limiting the number of images that can be made in a single night's observation session.

There has not been an easy way to overcome these limitations. While some progress has been made with the introduction of CCD still or video cameras, which are capable of producing near real time images of objects not visible using an eyepiece and the naked eye, and while software has been developed to “stack” multiple images acquired with a CCD camera to produce high quality images with relatively inexpensive equipment, there is a limit to the improvements that these innovations have brought. Astronomers are still at the mercy of imperfections in the air columns through which their single telescopes are observing, and astrophotographers must still extend their exposure times to acquire enough high quality “stacked” images so that they will obtain a satisfactory final, summated image. Thus astronomers and astrophotographers have been limited by the quality of the images they can obtain from a single telescope/CCD video or other camera combination.

Exemplary embodiments described herein provide methods and systems for solving these problems: a dynamic method of summing images acquired from a plurality of telescope/CCD camera systems in real time, thus dramatically decreasing the length of time required to obtain high quality images of faint objects, and thereby decreasing susceptibility to local poor “seeing” conditions due to thermal and particulate interference in the air column over any individual telescope. Exemplary embodiments may employ a networked array of a plurality of telescope/CCD still or video camera combinations, so that poor “seeing” conditions over any one or more observing sites is mitigated by inputs from other sites where “seeing” is better at any given moment. In exemplary embodiments, the multiple observing and/or imaging sites may be networked and communicating with one another in real time.

Exemplary embodiments may provide a computerized system and method for the automatic co-registration and summation of multiple image “stacks” as they arrive over a network (or a plurality of networks) in real time from a plurality of sources, post-processing these summed images, storing and/or retrieving and/or delivering the resulting summed post-processed images locally and/or over one or more networks for display on one or more monitors (CRT, LCD, etc) in real time. Exemplary embodiments may include a networked solution that connects any number of telescope/CCD cameras in real time, so that the input from one or more is fed into a central algorithm that, on the fly, co-registers and stacks all incoming images, discards poor images, and stores and/or distributes the final image resulting from these manipulations back to one or more of the networked observation sites or other sites, so that at least some participating observers have access to the resulting final summed image in real time.

Exemplary embodiments may employ technologies (hardware and/or software) that are used to acquire, stack, store, and display images from a single input source, such as a single telescope and CCD camera. Further, exemplary embodiments may employ networking technologies to link one or more input sites together, to gather information from one or more sites in real time, and to distribute resulting summated images back to participating one or more observatories and/or other image consumers in real time.

Exemplary embodiments may provide automated, dynamic overlaying of stacks of images as they are being acquired from multiple sources, such as multiple telescopes with CCD cameras, and may produce real-time output of the resulting summed image on at least one video display device.

Exemplary embodiments may allow very high quality images to be acquired, saved, and/or displayed much more quickly, and with less susceptibility to atmospheric turbulence, than can a system relying on the input signal from a single source (for instance, a single telescope). Exemplary embodiments may allow groups of observers, whether nearby or distant from one another, or individual observers using a plurality of telescope/CCD camera input devices, to acquire high quality images quickly, and to share these images with each other or with other image consumers in real time. Exemplary embodiments effectively increase the number of observations and/or images that an individual observer using a plurality of telescopes/cameras, or that a group of observers using a plurality of telescopes/cameras, can acquire in a limited period of observation time. In an era of increasing light pollution, exemplary embodiments may effectively increase the sensitivity of all telescopes, including small aperture ones, allowing them to detect and image more faint astronomical objects than they otherwise could. By further enhancing the quality of images obtainable with relatively inexpensive equipment, embodiments increase opportunities for collaborations between networks of amateur astronomers and professional/governmental astronomers. Embodiments also empower professional astronomers and astrophotographers to produce higher quality images in less time than has heretofore been possible.

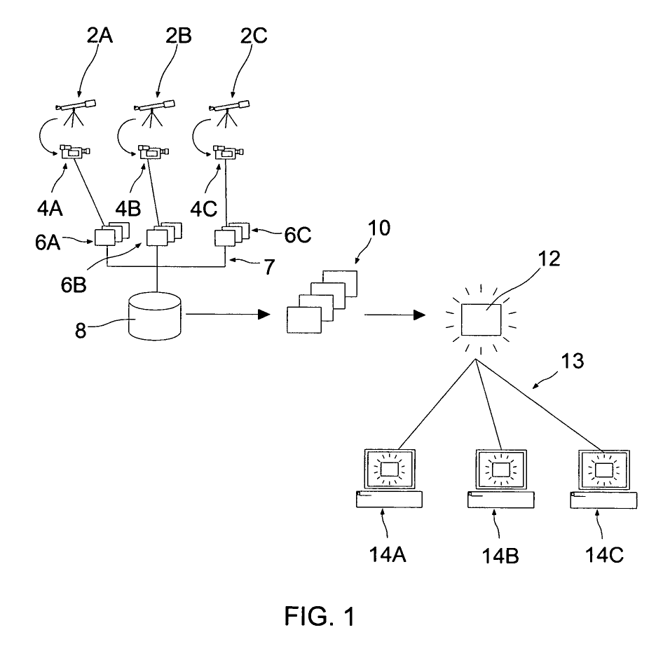

FIG. 1 provides a flow diagram of an exemplary embodiment, wherein any number of telescopes 2A, 2B, 2C at any number of observing sites that are each trained on the same astronomical object at a given moment, and that are each equipped with a camera 4A, 4B, 4C (such as a CCD still or video camera) produce “stacks” of images 6A, 6B, 6C that are sent via one or more computer networks 7 (for example, and without limitation, local area networks, wide area networks, or across the Internet) to one or more servers or local computer processors 8 which receive and collect the image stacks 6A, 6B, 6C, sums all images into a single stack, rejects images of poor quality, co-registers all images into a single high quality image stack 10, eliminates image noise and improves image signal via one or more image processing co-registration algorithms, producing one or more high quality images 12, which is at least one of stored and distributed across one or more computer networks 13 (which may be the same as network 7, or which may be a different network), whether local area networks, wide area networks, or the Internet, for display and/or capture and/or storage on one or more remote computers or other display monitors or devices 14, which may or may not be physically located at or near one or more of the observing sites.

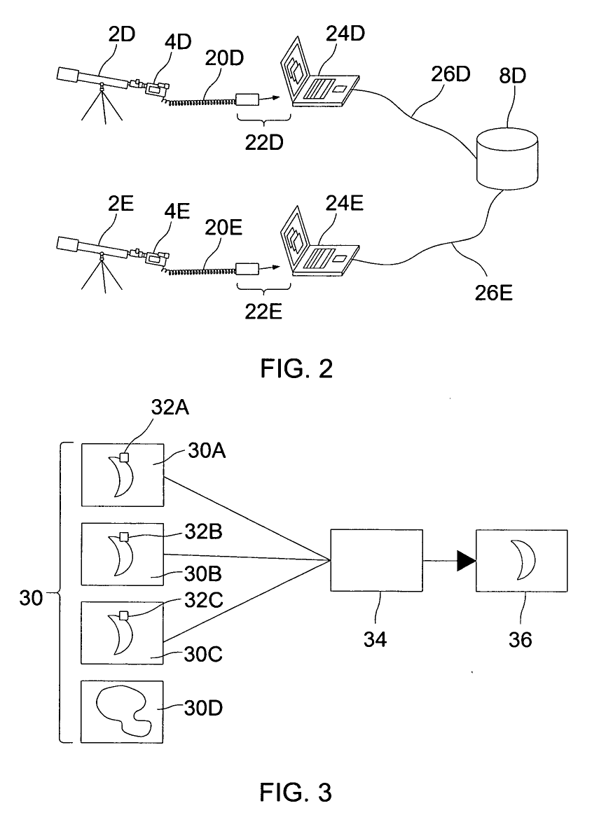

In an exemplary embodiment, the at least one camera can be mounted on each of the at least one telescopes and can be connected to a computer. For example, as depicted in FIG. 2, camera 4D is mounted on telescope 2D, and camera 4E is mounted on telescope 2E. The cameras may be connected to the computers using a variety of output cables including at least one of an S-video cable, RCA cable, or other cable, and thence to a device such as a RCA to USB 2 computer adapter (such as the Mallincam USB 2 Computer Adapter (http://mallincam.tripod.com), or the Win TV®-PVR-USB2 or the WinTV-HVR-1950 personal video recorder (www.hauppauge.com), or other such adapter devices that transfer streaming video images from the at least one telescope via the at least one cameras to at least one computers via the computers' USB ports, or other input methods. For example, as shown in FIG. 2, camera 4D is connected to computer 24D by cable 20D and adapter 22D, and camera 4E is connected to computer 24E by cable 20E and adapter 22E.

Widely available, separate screen capture software (such as the Snappy video frame grabber (Play incorporated), Snaglt® (www.techsmith.com), or others) running on the at least one computers 24D, 24E can then be used to convert these streaming video images into stacks of frames that can be in one of many formats including, but not limited to, JPG, BMP, AVI, etc.

Exemplary embodiments of the present invention may then send these stacks of frames via one or more computer networks 26D, 26E (including but not limited to local area networks, wide area networks, or across the Internet) to one or more servers or local computer processors 8D, which receive and collect the at least one image stacks to produce a single larger image stack composed of all the source image stacks from the plurality of source telescopes 2D, 2E.

In an exemplary embodiment, the single larger image stack 10 shown in FIG. 1 may be processed using image co-registration algorithms, such as Registax (http://www.astronomie.be/registax/index.html). Registax is designed to produce a single high quality, high signal, low noise image from a stack of at least one source images acquired from a single source such as a single telescope.

As depicted in FIG. 3, an exemplary image co-registration algorithm assesses each image in a stack 30 of at least one image 30A, 30B, 30C, 30D for sharpness and quality, and automatically rejects and discards any images below a user-defined lower threshold limit of quality. In this example, image 30D is rejected. For the remaining at least one image 30A, 30B, 30C, the software allows a user to define one or more alignment points 32A, 32B, 32C (or regions of interest) within the image, that the software uses in its co-registration processes, in order to maximize the signal to noise value and thus the sharpness of the resulting summed image. The co-registration software then uses an automatic image processing algorithm 34 to maximize the available signal while minimizing the noise from each of the at least one source images 30A, 30B, 30C of the stack 30, in order to produce a single high quality, high signal, low noise image 36 that reflects the total information contained within the at least one image stacks 30.

Exemplary embodiments may employ co-registration technology and algorithms. By selecting and centering within their field of view, and thus centering within the at least one image stack that they will each produce, a single target object at which each telescope is aimed at any given moment, the at least one telescope/observer selects a common target that can be used by the co-registration software for alignment and co-registration of the large image stack to produce a single high quality, high signal, low noise image that represents the total available useful information from the large image stack.

A user who is supervising the plurality of servers or local computer processors may be required to select at least one alignment point manually from each of the at least one source image stacks when target acquisition by the at least one telescopes/observers is initiated. However, in some embodiments, whether or not by prior agreement, each of the at least one observers operating the at least one telescopes might decide which stars or other objects or parts of objects to use as the alignment points for the co-registration software, and indicate these points to the co-registration software that is running on each of their own networked computers as they target the object with their telescope.

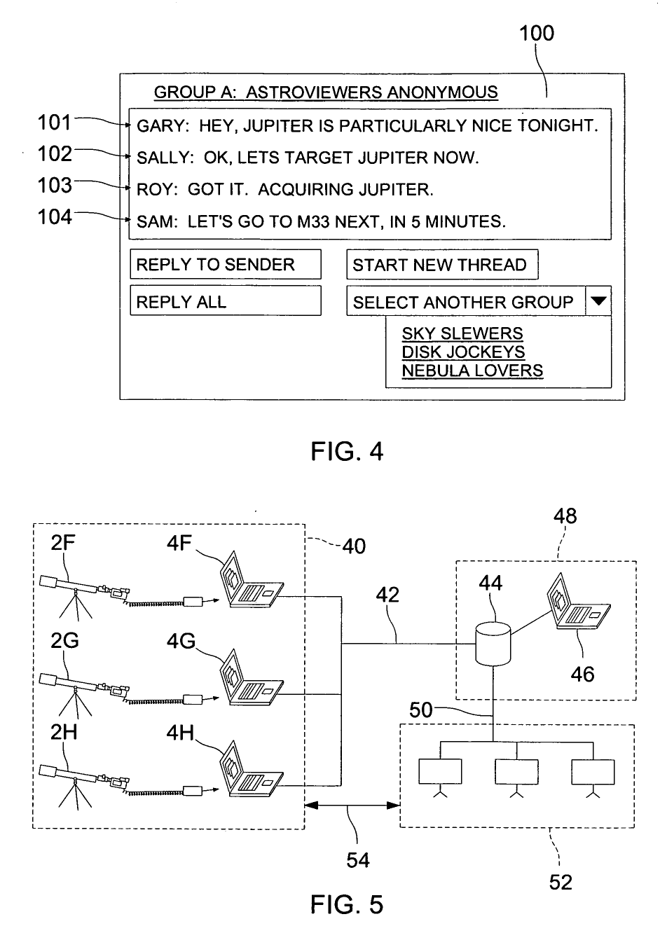

Alternatively, the co-registration software may be running on a networked server, such as in an ASP (application service provider) model, and simultaneously be accessible to one or many observers participating in the observation at any given moment. Additionally, the co-registration software may automatically select a region of interest within a target to use for its co-registration processes. Such a region of interest may be common to the targeted body being observed at any given moment by all participating telescopes/observers while they are observing a common target. Further, some exemplary embodiments may, to help broker communication between observers who in real time wish to select common targets, regions of interest within targets, and for other purposes, include instant messaging or other communication functionality using the plurality of computer networks to broker instant communication among observers. See FIG. 4, which depicts an exemplary instant messaging communications window 100 showing communications between several observers 101, 102, 103, 104. Other communication functionality may include voice and/or data.

In an exemplary embodiment, once alignment point information is entered by the one or many observers, or once alignment point information is selected automatically by the computer system, the system may then relay this alignment point information across the at least one computer networks to the one or many servers or computer processors that will utilize the information to perform image co-registration, so that no manual intervention may be required of any human supervisor of the plurality of servers or local computer processors.

An exemplary embodiment may then perform at least one of storage and distribution of the at least one resulting high quality image across at least one computer network, whether a local area network, wide area network, or the Internet, for display and/or capture and/or storage on one or more remote client computers or other client display monitors or devices which may then display the at least one high quality image. Such display devices may or may not be physically located near or at the observing sites. Such distribution may or may not occur in real time, near real time, or in delayed fashion, whether by pushing images across the one or more networks as they become available or storing them in an image archive for later retrieval, whether or not by user query.

In exemplary embodiments, it is possible but not necessary that the at least one client display monitors may be located at or near the same physical location as the at least one telescope/observer sites. The client display monitor may be located anywhere, as long as they have access to the computer networks being used to distribute the at least one high quality image, so that they are able to receive these images.

In exemplary embodiments, the plurality of servers and computer processors could be, but need not be, located at a single physical site. In fact, any number of servers or local computer processors at a plurality of physical locations could receive the source image stacks and process them in real time, in near real time, or in delayed fashion, independently of any other server or computer performing similar co-registration and image processing functions at the same time, or at a different time, using the same, or partly overlapping, or completely different at least one source image stacks.

Exemplary embodiments can simultaneously be used by one or many groups of observers, or by a single observer using one or many telescopes at one or many observing sites, to observe one or many objects simultaneously, wherein at any given moment at least one telescope is targeting at least one of many target objects. For example, a single observer might use 6 telescopes and multiple instances of the invention to target 3 objects, with 2 telescopes targeting each of the 3 objects simultaneously, while the system displays a continuously updated high quality image of each target object on each of 3 monitors. Similarly, a group of observers scattered across a wide geographic area might collaborate to use the system to obtain high quality images of target objects more quickly than they could independently.

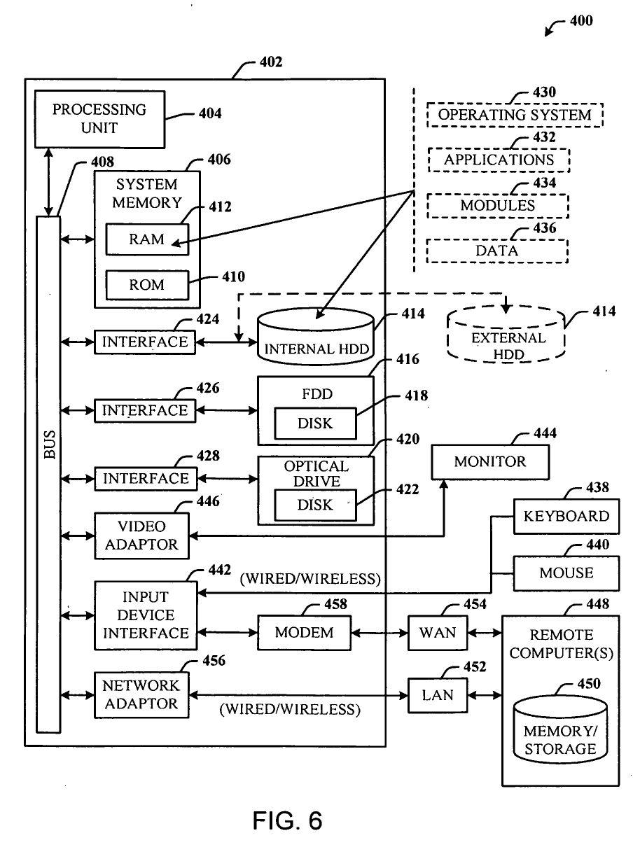

FIG. 5 is an illustration of some of many possible exemplary embodiments of the network connectivity of the present invention. One or more observational stations, each includes at least one telescope 2F, 2G, 2H and at least one computer 4F, 4G, 4H, comprise an observer network 40 that may be linked both internally via at least one of a local area network, wide area network, and the Internet, as well as via similar network connectivity 42 to at least one server array 44 and computer processor 46 in an image processing server array 48 that may be linked both internally via at least one of a local area network, wide area network, and the Internet, as well as via similar network connectivity 50 to at least one client display monitor 52 that may include any number of desktop, laptop computers, servers, and other networked access points, including one or more of the computers 4F, 4G, 4H that are located at the observing stations. Additional network connectivity 54 links the observer network 40 with the display network 52. Co-registration image processing may occur at any of the at least one servers and processors in any of the observer network 40, the processor network 48, and the display network 52. Co-registration and display of images may occur at any number of sites simultaneously. Subsets of observers 2F, 2G, 2H may target any number of objects, and may display those or other objects via co-registration image processing of shared image stacks, at any given point in time, and may switch targets as grouped subsets as agreed, whether by pre-determined plan or via on the fly communication such as instant messaging, voice communication, or data communication. Such communication may or may not be brokered via one or more of the one or more computer networks, cellular telephone technology, landline telephone, direct verbal communication, or other methods.

Exemplary embodiments offer a significant improvement over the prior art to both individuals and organizations of a plurality of astronomers and/or astrophotographers wishing to acquire and/or capture and/or store and/or share high quality images in real time using a plurality of telescopes/CCD still or video or other cameras.

Exemplary embodiments may provide a significant reduction in the time required to acquire a large number of stacked images, since a plurality of image input sources is utilized. Additionally, exemplary embodiments may provide a reduction in the susceptibility of image quality to perturbations in the atmosphere above any particular observation site, since a plurality of sites can be networked, reducing reliance on the quality of “seeing” at any particular site at any particular time. Further, exemplary embodiments may facilitate networking of observers so that all can benefit from the power of multiple observing sites and input sources, providing all participants and observers with higher quality images than they could obtain individually, regardless of the size or quality of the equipment available to them as individuals. Exemplary embodiments may enhance the sensitivity of even small aperture telescopes such that they may be rendered useful to professional astronomers, on the basis of the contributions that even small telescopes may make to the quality of summated images on which the professional astronomer may depend. Exemplary embodiments may provide improved utility to even the individual astronomer of owning and operating a plurality of telescope/camera systems using an embodiment on a local area network, wide area network or the Internet, whether doing so at only a single observatory and/or observing site, or using the embodiment at more than one observatories and observing sites, on the basis of improved speed of acquisition of high quality images that can be obtained by combining a plurality of inputs, and on the basis of improved sensitivity to faint astronomical objects of even small aperture telescopes, when they are networked and their outputs are combined.

It is within the scope of the disclosure to utilize image sensing devices other than CCD video cameras. Exemplary embodiments may employ cameras designed to produce static images. For example, astrophotography CCD cameras such as the Meade Deep Sky Imager III™ Color CCD Camera or the Meade Deep Sky Imager PRO III Color CCD Camera (http://www.meade.com), or the Santa Barbara Instrument Group (SBIG) line of CCD cameras (http://www.sbig.com/sbwhtmls/online.htm), can be used. In such embodiments, the camera captures a stack of images over a period of seconds, minutes, or hours. This source stack of images may serve as at least one of the source image stacks in the above description, and may be used in a manner similar to the use of the source image stacks acquired with video cameras.

Subsequent collection, summation, co-registration, image post-processing, distribution and other operations involving these source image stacks may occur similarly as described above. In other exemplary embodiments, source image stacks acquired by video CCD cameras and still CCD cameras may be combined and used to produce single high quality images in a manner similar to that used to produce high quality images from source image stacks acquired from exclusive use of either video or still CCD cameras.

In such embodiments, a single astronomer or groups of astronomers may use any combination of one or more video and still CCD cameras to collect image stacks for co-registration, summation, post-processing, distribution, sharing, and other uses as above. Such embodiments have the advantage of not restricting collaborators to use of only video or only still CCD cameras; a single astronomer possessing two telescopes and one still CCD camera and one video CCD camera may employ both cameras simultaneously to enjoy the benefits of the invention.

Exemplary embodiments may employ Digital Single-Lens Reflex (DSLR) cameras made by manufacturers such as Canon (such as the Canon 10D and Canon 20D), and Nikon (such as the Nikon D70). In such embodiments, the at least one DSLR camera produces at least one stack of images that, as for still CCD cameras, may serve as the source image stacks as described above. Further embodiments may employ image stacks acquired from any combination of at least one of CCD video, CCD still, and DSLR cameras, using such image stacks in a manner similar to that described above.

In exemplary embodiments, image sensing devices may be adapted to produce images from portions of the electromagnetic spectrum that are not visible to the human eye, such as the infrared and ultraviolet portions of the spectrum. Further, image sensing devices and their corresponding telescopes may be adapted to be controlled remotely such that a human operator need not be physically present to perform various steps described herein.

Exemplary embodiments may be used in contexts other than astrophotography. For example, embodiments may employ other imaging devices such as security still or video cameras that may operate in low light conditions. In such embodiments, the at least one still or video camera may be used to monitor the same target from a similar vantage point, such that the images may be stacked and co-registered in real time or near real time and displayed on at least one video or computer monitor and may be used by at least one human operator for one or more purposes such as live observation and storage for future retrieval. In such embodiments, the surveillance system may offer increased light sensitivity, and thus improved performance in low light conditions, because it displays images generated from more than one camera source. Such embodiments offer the additional advantage of redundancy such that failure for any reason of at least one camera, such as failure due to temporary obstruction of view or temporary or permanent loss of mechanical function, does not cause complete loss of a surveillance image.

As used herein, “real time” means substantially at the same time as events occur, images are acquired, etc., and includes “near real time” (i.e., allowing for further delays to the extent that it still appears to an end user that the processing is occurring substantially as the data is being collected).

Although many of the exemplary embodiments described herein incorporate CCD still or video cameras, it is within the scope of the invention to utilize any other image sensing system or device that is capable of sensing an image (visible or invisible to the human eye) and converting the image into a digital representation of the image. For example, and without limitation, image sensing devices may include CCD still or video cameras, other still or video cameras, digital single lens reflex cameras, security cameras, and others.

Exemplary methods may be implemented in the general context of computer-executable instructions that may run on one or more computers, and exemplary methods may also be implemented in combination with program modules and/or as a combination of hardware and software. Generally, program modules include routines, programs, components, data structures, etc., that perform particular tasks or implement particular abstract data types. Moreover, those skilled in the art will appreciate that exemplary methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices. Exemplary methods may also be practiced in distributed computing environments where certain tasks are performed by remote processing devices that are linked through a communications network. In a distributed computing environment, program modules can be located in both local and remote memory storage devices.

An exemplary computer typically includes a variety of computer readable media. Computer readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

With reference to FIG. 6, an exemplary computing system 400 includes a computer 402 including a processing unit 404, a system memory 406, and a system bus 408. The system bus 408 provides an interface for system components including, but not limited to, the system memory 406 to the processing unit 404. The processing unit 404 can be any of various commercially available processors, for example. Dual microprocessors and other multi processor architectures may also be employed as the processing unit 404. The system bus 408 can be any of several types of bus structure that may further interconnect to a memory bus (with or without a memory controller), a peripheral bus, and a local bus using any of a variety of commercially available bus architectures. The system memory 406 includes read-only memory (ROM) 410 and random access memory (RAM) 412. A basic input/output system (BIOS) is stored in a non-volatile memory 410 such as ROM, EPROM, EEPROM, which BIOS contains the basic routines that help to transfer information between elements within the computer 402, such as during start-up. The RAM 412 can also include a high-speed RAM such as static RAM for caching data.

The computer 402 further includes an internal hard disk drive (HDD) 414 (e.g., EIDE, SATA), which internal hard disk drive 414 may also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The hard disk drive 414, magnetic disk drive 416 and optical disk drive 420 can be connected to the system bus 408 by a hard disk drive interface 424, a magnetic disk drive interface 426 and an optical drive interface 428, respectively. The interface 424 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and RAM 412, including an operating system 430, one or more application programs 432, other program modules 434 and program data 436. All or portions of the operating system, applications, modules, and/or data can also be cached in the RAM 412. It is to be appreciated that the disclosed architecture can be implemented with various commercially available operating systems or combinations of operating systems.

A user can enter commands and information into the computer 402 through one or more wire/wireless input devices, for example, a keyboard 438 and a pointing device, such as a mouse 440. Other input devices (not shown) may include a microphone, an IR remote control, a joystick, a game pad, a stylus pen, touch screen, or the like. These and other input devices are often connected to the processing unit 404 through an input device interface 442 that is coupled to the system bus 408, but can be connected by other interfaces, such as a parallel port, an IEEE 1394 serial port, a game port, a USB port, an IR interface, etc.

A monitor 444 or other type of display device is also connected to the system bus 408 via an interface, such as a video adapter 446. In addition to the monitor 444, a computer typically includes other peripheral output devices (not shown), such as speakers, printers, etc.

The computer 402 may operate in a networked environment using logical connections via wire and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically includes many or all of the elements described relative to the computer 402, although, for purposes of brevity, only a memory/storage device 450 is illustrated. The logical connections depicted include wire/wireless connectivity to a local area network (LAN) 452 and/or larger networks, for example, a wide area network (WAN) 454. Such LAN and WAN networking environments are commonplace in offices and companies, and facilitate enterprise-wide computer networks, such as intranets, all of which may connect to a global communications network, for example, the Internet.

When used in a LAN networking environment, the computer 402 is connected to the local network 452 through a wire and/or wireless communication network interface or adapter 456. The adaptor 456 may facilitate wire or wireless communication to the LAN 452, which may also include a wireless access point disposed thereon for communicating with the wireless adaptor 456. When used in a WAN networking environment, the computer 402 can include a modem 458, or is connected to a communications server on the WAN 454, or has other means for establishing communications over the WAN 454, such as by way of the Internet. The modem 458, which can be internal or external and a wire and/or wireless device, is connected to the system bus 408 via the serial port interface 442. In a networked environment, program modules depicted relative to the computer 402, or portions thereof, can be stored in the remote memory/storage device 450. It will be appreciated that the network connections shown are exemplary and other means of establishing a communications link between the computers can be used.

The computer 402 is operable to communicate with any wireless devices or entities operatively disposed in wireless communication, for example, a printer, scanner, desktop and/or portable computer, portable data assistant, communications satellite, any piece of equipment or location associated with a wirelessly-detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices. Wi-Fi, or Wireless Fidelity, allows connection to the Internet from a couch at home, a bed in a hotel room, or a conference room at work, without wires. Wi-Fi is a wireless technology similar to that used in a cell phone that enables such devices, for example, computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

While exemplary embodiments have been set forth above for the purpose of disclosure, modifications of the disclosed embodiments as well as other embodiments thereof may occur to those skilled in the art. Accordingly, it is to be understood that the disclosure is not limited to the above precise embodiments and that changes may be made without departing from the scope as defined by the claims. Likewise, it is to be understood that the scope is defined by the claims and it is not necessary to meet any or all of the stated advantages or objects disclosed herein to fall within the scope of the claims, since inherent and/or unforeseen advantages may exist even though they may not have been explicitly discussed herein.

What is claimed is:

1. A method of producing an image comprising:
receiving a first stack of images acquired using a first image sensing device, where the first stack of images includes a plurality of images depicting a target object;
receiving a second stack of images acquired using a second image sensing device, where the second stack of images includes a plurality of images depicting the target object;
combining the first stack of images and the second stack of images to produce a combined stack of images; and
processing the combined stack of images to produce a final image.

2. The method of claim 1, further comprising eliminating at least one image from at least one of the first stack of images, the second stack of images, and the combined stack of images based upon a quality evaluation.

3. The method of claim 1, wherein the steps of receiving the first stack of images, receiving the second stack of images, combining the first stack of images and the second stack of images, and processing the combined stack of images are performed using a central computing device.

4. The method of claim 3, wherein the first stack of images is received by the central computing device from a first computing device; and wherein the method further includes, after the step of processing the combined stack of images, transmitting the final image to the first computing device.

5. The method of claim 4, wherein the second stack of images is received by the central computing device from a second computing device; and wherein the first computing device, the second computing device, and the central computing device are operatively connected via at least one network providing at least near real time communications capability.

6. The method of claim 4, wherein the first computing device is located near the first image sensing device; and wherein the central computing device is located remotely from the first image sensing device.

7. The method of claim 1, wherein the step of processing the combined stack of images includes co-registering the combined stack of images.

8. The method of claim 7, wherein co-registering the combined stack of images includes removing from the combined stack of images at least one image of a relatively lower quality.

9. The method of claim 8, wherein co-registering includes identifying at least one alignment point in each of the images in the combined stack of images.

10. The method of claim 9, wherein co-registering includes identifying a plurality of alignment points in each of the images in the combined stack of images.

11. The method of claim 1, wherein the first stack of images and the second stack of images each include images that were acquired during a particular period of time.

12. The method of claim 1, further comprising
receiving a communication from a first user associated with the first image sensing device, and
transmitting the communication to a second user associated with the second image sensing device.

13. The method of claim 1, further comprising, after the step of processing the combined stack of images, transmitting the final image to a receiving computing device not associated with the first image sensing device, the second image sensing device, or the central computing device.

14. The method of claim 13, wherein the receiving computing device includes a storage device, and wherein the storage device is operative to supply the final image upon request.

15. The method of claim 1, wherein the steps of receiving the first stack of images, receiving the second stack of images, combining the first stack of images and the second stack of images, and processing the combined stack of images are performed at least in near real time.

16. A method of producing an image comprising:
acquiring a first stack of images of an object using a first image acquisition device;
transmitting the first stack of images to a central computing device; and
receiving, from the central computing device, a final image the object produced using at least the first stack of images and a second stack of images;
wherein the second stack of images includes a plurality of images of the object acquired by a second image acquisition device and received by the central computing device.

17. The method of claim 16, further comprising eliminating at least one image from at least one of the first stack of images, the second stack of images, and the combined stack of images based upon a quality evaluation.

18. The method of claim 16, wherein the central computing device is located remotely from the first image acquisition device.

19. The method of claim 16, wherein the first stack of images and the second stack of images each include images that were acquired during a particular period of time.

20. The method of claim 16, further comprising
receiving a first communication from a user associated with the second image sensing device, and
transmitting a second communication to the user associated with the second image sensing device.

21. A system for producing an image comprising:
a first image sensing device operative to gather a first stack of images depicting an object;
a second image sensing device operative to gather a second stack of images depicting the object; and
at least one computing device operatively coupled to the first image sensing device and the second image sensing device;
wherein the computing device is operative to combine images from the first stack of images and images from the second stack of images into a combined stack of images; and
wherein the computing device is operative to process the combined stack of images to produce a final image.

22. The system of claim 21, wherein at least one of the first image sensing device and the second image sensing device is terrestrially located.

23. The system of claim 22, wherein the object is extraterrestrially located.

24. The system of claim 21, further comprising a storage device operatively coupled to the computing device; wherein the storage device includes a plurality of final images.

25. The system of claim 21, further comprising a display device located near the first image sensing device, wherein the image sensing device is operative to display the final image.

26. The system of claim 21, wherein at least one of the first image sensing device and the second image sensing device is operatively coupled to a telescope.
